(19) United States
(12) Patent Application Publication
(10) Pub. No.: US 2022/0149694 A1
(43) Pub. Date: May 12, 2022

(54) ROTOR FOR AN ELECTRIC MACHINE, HAVING IMPROVED AXIAL LOCKING OF A LAMINATED ROTOR CORE

(71) Applicant: Valeo Siemens eAutomotive Germany GmbH, Erlangen (DE)

(72) Inventors: Christoph Englert, Bad Neustadt a.d.Saale (DE); Bernhard Kessler, Bad Neustadt a.d.Saale (DE); Markus Rubi, Bad Neustadt a.d.Saale (DE); Alexander Schlereth, Bad Neustadt a.d.Saale (DE)

(73) Assignee: Valeo Siemens eAutomotive Germany GmbH, Erlangen (DE)

(21) Appl. No.: 17/521,655

(22) Filed: Nov. 8, 2021

(30) Foreign Application Priority Data
Nov. 9, 2020 (DE) 10 2020 214 046.4

(51) Int. Cl. H02K 7/00; H02K 1/27; H02K 15/03

(52) U.S. Cl. CPC H02K 7/003; H02K 15/03; H02K 1/276

(57) ABSTRACT

Specified is a rotor (2, 2a, 2b) for an electric machine (1), said rotor (2, 2a, 2b) comprising a rotor shaft (3); a laminated rotor core (4) which by way of an interference fit sits on the rotor shaft (3); a first rotor holder (6, 6a, 6b) which on the rotor shaft (3), so as to be adjacent to the laminated rotor core (4), is assembled on a first side of the latter with the aid of an interference fit; and/or a second rotor holder (7, 7a, 7b) which on the rotor shaft (3), so as to be adjacent to the laminated rotor core (4), is assembled on a second, opposite side of the latter with the aid of an interference fit. Moreover specified are an electric machine (1) having such a rotor (2, 2a, 2b) and a vehicle (22) having such an electric machine (1).

### TECHNICAL FIELD

The invention relates to a rotor of an electric machine, to an electric machine having such a rotor, and to a vehicle having such an electric machine.

### PRIOR ART

When the laminated rotor core is assembled on the rotor shaft, the laminated rotor sheets are pressed on top of one another by a press device such that ideally no air gaps, or only minor air gaps, are created between the laminated rotor sheets. The laminated rotor sheets by virtue of inevitable deviations from the planar shape act as a spring assembly. An undesirable delamination of the laminated rotor core, or an undesirable separation of the laminated rotor sheets, respectively, can arise over time in the operation of the electric machine.

### DISCLOSURE OF THE INVENTION

It is therefore an object of the invention to specify an improved electric rotor of an electric machine, an improved electric machine as well as an improved vehicle. A delamination of the laminated rotor core, or a separation of the laminated rotor sheets, respectively, (arising especially during the operation of the electric machine) is in particular to be effectively prevented.

The object of the invention is achieved by a rotor for an electric machine, said rotor comprising a rotor shaft; a laminated rotor core which by way of an interference fit sits on the rotor shaft; and a first rotor holder which, so as to be adjacent to the laminated rotor core, is disposed on a first side of the latter, and a second rotor holder which, so as to be adjacent to the laminated rotor core, is disposed on a second, opposite side of the latter. The first rotor holder and/or the second rotor holder here are/is assembled on the rotor shaft with the aid of an interference fit.

It can in particular be provided that the interference fit is the sole axial locking mechanism of the first rotor holder and/or of the second rotor holder.

The object of the invention is furthermore achieved by a method for producing a rotor for an electric machine, said method comprising the following steps:

a) providing a rotor shaft;

b) pressing a laminated rotor core onto the rotor shaft;

c1) pressing a first rotor holder onto the rotor shaft so as to be adjacent to the laminated rotor core on a first side of the latter; and/or

c2) pressing a second rotor holder onto the rotor shaft so as to be adjacent to the laminated rotor core on a second, opposite side of the latter.

A longitudinal interference-fit unit is created by virtue of the laminated rotor core being pressed onto the rotor shaft.

The first rotor holder, the second rotor holder and the laminated rotor core are preferably pressed conjointly onto the rotor shaft, as a result of which in particular a longitudinal interference-fit unit composed of the rotor shaft, the laminated rotor core, the first rotor holder and the second rotary holder is created.

It can be in particular provided here that the first rotor holder and/or the second rotor holder, when being pressed onto the rotor shaft, thus under the influence of force, is heated so as to facilitate the press-fitting procedure.

One aspect of the invention relates to a method for producing a rotor for an electric machine, said method comprising the following method steps:
providing a rotor shaft and a laminated rotor core;
aligning a first rotor holder and a second rotor holder relative to the laminated rotor core such that the first rotor holder bears on one end of the laminated rotor core and the second rotor holder bears on another end;
bracing the first and the second rotor holder with the laminated rotor core so as to obtain a braced composite from the first rotor holder, the second rotor holder and the laminated rotor core;
heating the braced composite and inserting the rotor shaft without force into the heated braced composite; and
allowing the heated braced composite having the rotor shaft inserted therein to cool so as to obtain the rotor.

One aspect of the invention relates to a method for producing a rotor for an electric machine, said method comprising the following method steps:
providing a cooled rotor shaft and a laminated rotor core;
aligning a first rotor holder and a second rotor holder relative to the laminated rotor core such that the first rotor holder bears on one end of the laminated rotor core and the second rotor holder bears on another end of the laminated rotor core;
bracing the first and the second rotor holder with to the laminated rotor core so as to obtain a braced composite from the first rotor holder, the second rotor holder and the laminated rotor core;
cooling the rotor shaft; and
inserting the rotor shaft without force into the braced composite; and
warming the braced composite having the rotor shaft inserted therein so as to obtain the rotor.

The bracing of the first and the second rotor holder with the laminated rotor core can take place by means of a workpiece carrier. The braced composite is optionally heated using the workpiece carrier, and the rotor shaft without the influence of force heated in the composite disposed in the workpiece carrier, and the braced composite is subsequently cooled having the rotor shaft inserted in the latter.

By inserting the rotor shaft without the influence of force into the braced composite, or into the heated braced composite, respectively, a so-called transverse interference fit unit is in particular created.

The object of the invention is moreover achieved by an electric machine which comprises a stator as well as a rotor of the above-mentioned type, the latter in relation to the stator being mounted so as to be rotatable about the rotation axis of the rotor.

Finally, the object is also achieved by a vehicle with at least two axles, of which at least one is driven, wherein said driving action is performed at least partially or temporarily by the above-mentioned electric machine.

By an interference fit being provided for a rotor holder, additional means which would lock the axial position of the first rotor holder and/or of the second rotor holder can be dispensed with. This means that shaft locking rings, shaft nuts or the like can be omitted. As a result, axial installation space can be saved, this resulting in the electric machine being of a very short construction. Nevertheless, an undesirable delamination of the laminated rotor core, or an undesirable separation of the laminated rotor sheets, respectively, is effectively precluded as the rotor holders reliably hold the laminated rotor sheets in position even during the operation of the electric machine.

It is to be noted at this point that it is indeed advantageous for both rotor holders to be assembled on the rotor shaft with the aid of an interference fit, but that it is also possible for one of the two rotor holders to be axially locked in another manner, for example by a shaft collar on the rotor shaft or a shaft locking ring.

A rotor holder is characterized in particular in that said rotor holder is at least three times as thick as a laminated rotor sheet. This means that a rotor holder is substantially more stable than a laminated rotor sheet.

It is advantageous for the first rotor holder and/or the second rotor holder to be made from a (ferromagnetic) quenched and tempered steel. These types of steel have a high strength and are therefore particularly suitable for achieving the set object. Examples of high-strength steel include 42 CroMo4 as well as spring steel C67.

It is also particularly advantageous for the minimum spacing between the first rotor holder and permanent magnets disposed in the laminated rotor core, and/or the minimum spacing between the second rotor holder and permanent magnets disposed in the laminated rotor core (in an end plane of the laminated rotor core which is normal to a rotation axis of the rotor) to be 4 mm. As a result, the first rotor holder and/or the second rotor holder are/is disposed sufficiently outside the magnetic circle formed in the laminated rotor core such that negative effects on the latter remain minor even when a ferromagnetic quenched and tempered steel is used for the rotor holders. In other words, by virtue of the proposed minimum spacing, high-strength steel can be used for the rotor holders without significant negative effects on the magnetic circle having to be expected.

In general, the external contour of the first rotor holder and/or of the second rotor holder can be, for example,

i) circular-cylindrical; or

ii) radial, wherein the first rotor holder and/or the second rotor holder have/has as many arms as the rotor has magnetic poles, and the arms of the first rotor holder and/or of the second rotor holder are disposed between the magnetic poles. Embodiment i) offers the advantage that said embodiment i) can be produced in a particularly simple manner; embodiment ii) in contrast offers the advantage that the laminated rotor core as a result of the arms is positively held together even radially far outside. As a result of the arms of the first rotor holder and/or of the second rotor holder being disposed between the magnetic poles, the magnetic circle formed in the laminated rotor core is not, or only slightly, influenced by the rotor holders.

It is furthermore favourable for bores which are disposed in the laminated rotor core and of which some are populated by balancing weights to be kept clear in the first rotor holder and/or in the second rotor holder. In this way, the rotor can be balanced by selectively inserting balance weights into the bores provided to this end, even in the assembled state of the rotor holders.

It is furthermore favourable for the first rotor holder and/or the second rotor holder in the region of a connecting means to be kept clear for aligning and/or connecting laminated rotor sheets of the laminated rotor core. For example, tabs of the laminated rotor sheets can in each case be bent back somewhat in order for the laminated rotor sheets to be connected and aligned. Pins which run through the laminated rotor core are also examples of connecting means for aligning and/or connecting the laminated rotor sheets of the laminated rotor core. It is avoided as a result of the clearances that the rotor holders in the assembled state bear on the laminated rotor core only in a punctiform manner and a contact pressure is undesirably distributed in a non-uniform manner.

Finally, it is also advantageous for the first rotor holder and/or the second rotor holder to be stamped or cut from a metal sheet and only the internal diameter of a press-fit to be machined by turning and/or grinding. The rotor holders can be produced in a particularly economical manner as a result.

### BRIEF DESCRIPTION OF THE FIGURES

Exemplary embodiments of the invention are illustrated in an exemplary manner in the appended schematic figures. In the figures:

FIG. 1 shows a schematic half-sectional view of an exemplary electric machine;

FIG. 2 shows a first example of a rotor in an oblique view;

FIG. 3 shows the first rotor holder for the rotor from FIG. 2 in an oblique view from the front;

FIG. 4 shows the second rotor holder for the rotor from FIG. 2 in an oblique view from the rear;

FIG. 5 shows a front view of the rotor from FIG. 2;

FIG. 6 shows a second example of a rotor in an oblique view;

FIG. 7 shows the first rotor holder for the rotor from FIG. 6 in an oblique view from the front;

FIG. 8 shows the second rotor holder for the rotor from FIG. 6 in an oblique view from the rear;

FIG. 9 shows a front view of the rotor from FIG. 6; and

FIG. 10 shows an electric machine of the proposed type, said electric machine being installed in a vehicle.

### DETAILED DESCRIPTION OF THE INVENTION

As an introduction it is noted that identical parts in the different embodiments are provided with the same reference signs or same component designations, optionally with different indices. The disclosures of a component contained in the description may be transferred in an analogous manner to another component with the same reference sign or same component designation. Also, the positional indications chosen in the description, such as e.g. “top”, “bottom”, “rear”, “front”, “side” etc. relate to the figure directly described and depicted, and in the event of a changed position, should be applied in an analogous manner to the new position.

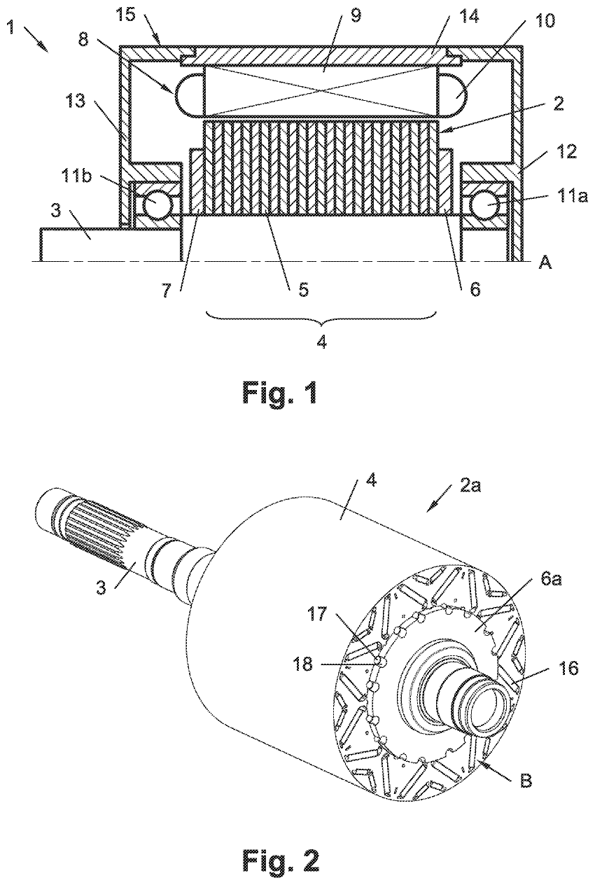

FIG. 1 shows a half section through a schematically illustrated electric machine 1. The electric machine 1 comprises a rotor 2 having a rotor shaft 3, and a laminated rotor core 4 which sits on the rotor shaft 3 and has a plurality of laminated rotor sheets 5 stacked on top of one another. Moreover, the rotor 2 comprises a first rotor holder 6 which, so as to be adjacent to the laminated rotor core 4, is disposed on a first side of the latter, and a second rotor holder 7 which, so as to be adjacent to the laminated rotor core 4, is disposed on a second, opposite side of the latter. The first rotor holder 6 and the second rotor holder 7 serve for axially locking the laminated rotor core 4 such that the latter cannot separate in the operation of the electric machine 1. The laminated rotor core 4 as well as the first rotor holder 6 and the second rotor holder 7 are assembled on the rotor shaft 3 with the aid of an interference fit. The mentioned interference fit is in particular the sole axial locking mechanism of the first rotor holder 6 and of the second rotor holder 7. This means that there are in this case no shaft locking rings, shaft nuts or the like which would additionally lock the axial position of the first rotor holder 6 and of the second rotor holder 7.

The electric machine 1 furthermore comprises a stator 8 having a laminated stator core 9 having a plurality of laminated stator sheets, which in this example are not individually illustrated, as well as stator windings 10 disposed in said laminated stator sheets. With the aid of (roller) bearings 11a, 11b, the rotor 2, or the rotor shaft 3, respectively, in relation to the stator 8 is mounted so as to be rotatable about a rotation axis A. Specifically, the first bearing 11a sits in a first end shield 12, and the second bearing 11b sits in a second end shield 13. Furthermore, the electric machine 1 comprises a (central) housing part 14 which connects the first end shield 12 and the second end shield 13 and receives the stator 8. The first end shield 12, the second end shield 13 and the housing part 14 in this example form the housing 15 of the electric machine 1.

FIG. 2 now shows a first, somewhat more detailed, embodiment of a rotor 2a in an oblique view. The rotor 2a has a rotor shaft 3 as well as a laminated rotor core 4 which sits on the latter, and rotor holders 6a, 7a which sit on the laminated rotor core 4 and of which only the first rotor holder 6a is however visible in FIG. 2. The rotor 2a moreover comprises magnets 16 which are disposed in the laminated rotor core 4, as well as bores 17 which for receiving balancing weights are disposed in the laminated rotor core 4.

The external contour of the first rotor holder 6a is substantially circular-cylindrical, but said first rotor holder 6a comprises optional recesses 18 in the region of the bores 17. In other words, the bores 17 in the first rotor holder 6a are kept clear. As a result, the rotor 2a can be balanced in a state in which the rotor holders 6a, 7a are assembled on the rotor shaft 3.

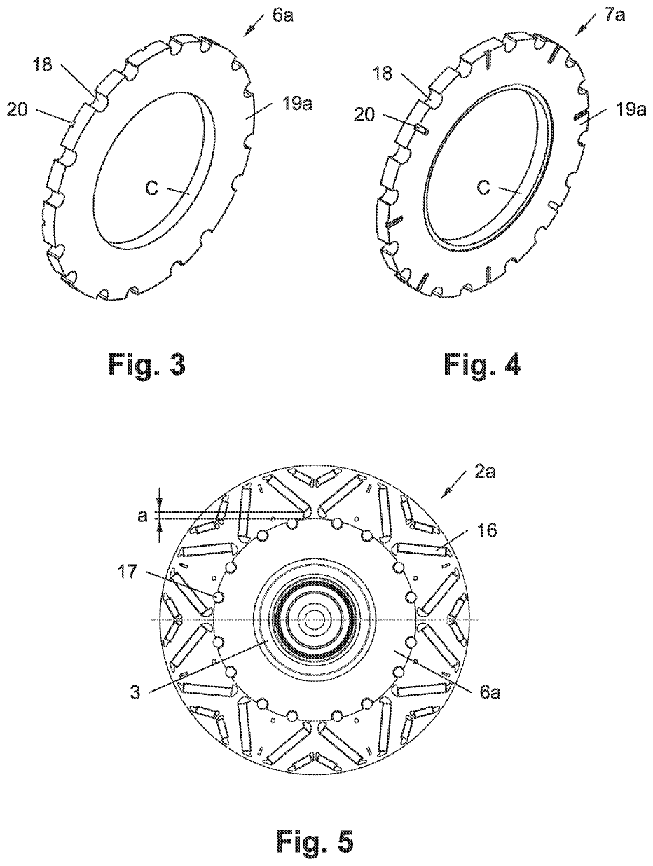

FIG. 3 now shows an oblique view of the first rotor holder 6a from the front, and FIG. 4 shows an oblique view of the second rotor holder 7a from the rear. The two rotor holders 6a, 7a in this example are of identical design, which is why FIGS. 3 and 4 can also be interpreted such that said figures show the front and the rear side of a single rotor holder 6a, 7a. Therefore, identical parts are provided with the same reference signs in FIGS. 3 and 4. The identical construction of the rotor holders 6a, 7a is indeed advantageous but not mandatory, and the rotor holders 6a, 7a may also be of different designs.

The rotor holders 6a, 7a comprise a disc-shaped main body 19a having the recesses 18 for the bores 17, and further optional clearances 20 which in the assembled state serve for aligning and/or connecting the laminated rotor sheets 5 of the laminated rotor core 4 in regions of connecting means. For example, tabs of the laminated rotor sheets 5 can in each case be bent back somewhat in order for the laminated rotor sheets 5 to be connected and aligned. Pins which run through the laminated rotor core 4 are also examples of connecting means for aligning and/or connecting the laminated rotor sheets 5 of the laminated rotor core 4. It is avoided as a result of the clearances 20 that the rotor holders 6a, 7a in the assembled state bear on the laminated rotor core 4 only in a punctiform manner and a contact pressure is undesirably distributed in a non-uniform manner.

The rotor 2, 2a is produced in that

a) the rotor shaft 3 is provided,

b) the laminated rotor core 4 is pressed onto the rotor shaft 3;

c1) the first rotor holder 6, 6a is pressed onto the rotor shaft 3 so as to be adjacent to the laminated rotor core 4 on a first side of the latter; and

c2) the second rotor holder 7, 7a is pressed onto the rotor shaft 3 so as to be adjacent to the laminated rotor core 4 on a second, opposite side of the latter.

The sequence of steps c1) and c2) here is of minor relevance and can also be reversed. In particular, the first rotor holder 6, 6a and/or the second rotor holder 7, 7a, during or prior to the press-fitting, respectively, can be heated to the rotor shaft 3.

Alternatively, the rotor 2, 2a can be produced in that
the rotor shaft 3 and the laminated rotor core 4 are provided;
the first rotor holder 6 and the second rotor holder 7a are aligned relative to the laminated rotor core 4 such that the first rotor holder 6 bears on one end of the laminated rotor core 4 and the second rotor holder 7a bears on another end of the laminated rotor core 4;
the first and the second rotor holder 7, 7a are braced with the laminated rotor core 4 so as to obtain a braced composite from the first rotor holder 6, the second rotor holder 6a and the laminated rotor core 4;
the braced composite is heated and the rotor shaft 3 is inserted into the heated braced composite; and
the heated braced composite having the rotor shaft 3 inserted therein is cooled so as to obtain the rotor 2, 2a.

It is also possible for the rotor 2, 2a to be produced as follows:
providing a cooled rotor shaft 3 and a laminated rotor core 4;
aligning a first rotor holder 6 and a second rotor holder 6a relative to the laminated rotor core 4 such that the first rotor holder 6 bears on one end of the laminated rotor core 4 and the second rotor holder 7a bears on another end of the laminated rotor core 4;
bracing the first and the second rotor holder 7, 7a with the laminated rotor core 4 so as to obtain a braced composite from the first rotor holder 6, the second rotor holder 7a and the laminated rotor core 4;
inserting a cooled rotor shaft 3 without force into the braced composite; and
warming the braced composite having the rotor shaft 3 inserted therein so as to obtain the rotor 2, 2a.

It is also conceivable that the first rotor holder 6, 6a and/or the second rotor holder 7, 7a are/is stamped or cut from a metal sheet. It is advantageous here for only the internal diameter C of a press-fit to be machined by turning and/or grinding but for the first rotor holder 6, 6a and/or the second rotor holder 7, 7a otherwise not to be machined by turning. As a result said rotor can be produced in a particularly economical manner.

FIG. 5 now shows the rotor 2a in a front view. In this view it can be readily seen that the first rotor holder 6a overall is spaced apart from the permanent magnets 16 disposed in the laminated rotor core 4. The minimum spacing a between the first rotor holder 6a and the permanent magnet 16 is advantageously a=4 mm (measured in the end plane B which is normal to the rotation axis A of the rotor 2a). The same applies to the second rotor holder 7a. In this way, the magnetic field in the rotor 2a is not, or only slightly, influenced by the rotor holders 6a, 7a even when the first rotor holder 6a and/or the second rotor holder 7a are/is made from a (ferromagnetic) quenched and tempered steel so as to withstand particularly high stresses.

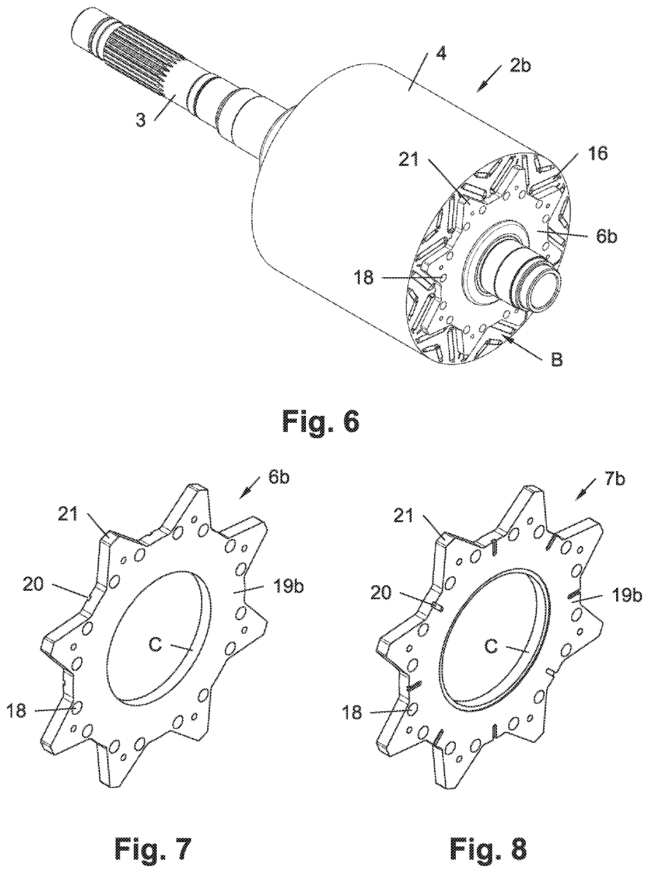

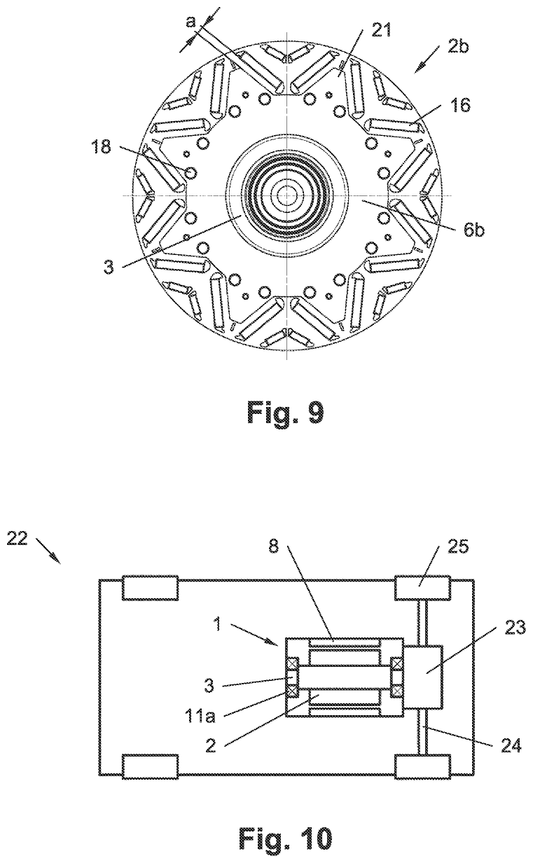

FIGS. 6 to 9 are equivalent to FIGS. 2 to 5 but show a further embodiment of a rotor 2b which is very similar to the embodiment of the rotor 2a illustrated in FIGS. 2 to 5. As opposed to the circular-cylindrical rotor holders 6a, 7a, radial rotor holders 6b, 7b are now provided, wherein the first rotor holder 6b and/or the second rotor holder 7b have/has as many arms 21 as the rotor 2b has magnetic poles. Specifically, the arms 21 of the first rotor holder 6b and/or of the second rotor holder 7b are disposed between the magnetic poles. In the example illustrated in FIGS. 6 to 9, the rotor 2b has eight magnetic poles and consequently also eight arms 21. This number is however purely exemplary, and more or fewer than eight magnetic poles and arms 21 may also be provided.

The remaining variants of embodiment and advantages resulting from the latter can be acquired from the rotor 2a illustrated in FIGS. 2 to 5. This relates in particular to:
the optional recesses 18 in the region of the bores 17 for the balancing weights;
the identical construction of the rotor holders 6b, 7b;
the optional clearances 20 in the region of connecting means for aligning and/or connecting the laminated rotor sheets 5;
the production method for the rotor 2, 2a, 2b;
the choice of materials for the rotor holders 6b, 7b; and
the spacing of the rotor holders 6b, 7b from the permanent magnets 16.

It is to be noted at this point that it is indeed advantageous for both rotor holders 6, 7, 6a, 7a, 6b, 7b to be assembled on the rotor shaft 3 with the aid of an interference fit, but that it is also possible for one of the two rotor holders 6, 7, 6a, 7a, 6b, 7b to be axially locked in another manner, for example by a shaft collar on the rotor shaft 3 or a shaft locking ring.

FIG. 10 finally shows the electric machine 1 installed in a vehicle 22. The vehicle 22 has at least two axles, at least one of which is driven. Specifically, the electric machine 1 is connected to the half-axles 24 of the rear axle via an optional transmission 23. Finally, the driven wheels 25 are mounted on the half-axles 24. The driving action of the vehicle 22 is performed at least partially or temporarily by the electric machine 1. This means that the electric machine 1 may serve for exclusively driving the vehicle 22, or for example may be provided in conjunction with an internal combustion engine (hybrid drive).

Finally, it is established that the scope of protection is determined by the patent claims. The description and the drawings should however serve as reference for interpretation of the claims. The features contained in the figures may be interchanged and combined with one another arbitrarily. In particular, it is also noted that the devices illustrated may in reality comprise even more or else fewer component parts than illustrated. In some cases, the illustrated devices or the component parts thereof may also not be depicted to scale, and/or may be enlarged and/or reduced.

1. A rotor for an electric machine, comprising
a rotor shaft;
a laminated rotor core which by way of an interference fit sits on the rotor shaft;
a first rotor holder which, so as to be adjacent to the laminated rotor core, is disposed on a first side of the latter; and
a second rotor holder which, so as to be adjacent to the laminated rotor core, is disposed on a second, opposite side of the latter,
wherein the first rotor holder and/or the second rotor holder are/is assembled on the rotor shaft with the aid of an interference fit.

2. The rotor according to claim 1, wherein the first rotor holder and/or the second rotor holder are/is made from a quenched and tempered steel.

3. The rotor according to claim 1, wherein the external contour of the first rotor holder and/or the second rotor holder are/is circular-cylindrical or radial, wherein the first rotor holder and/or the second rotor holder have/has as many arms as the rotor has magnetic poles, and the arms of the first rotor holder and/or of the second rotor holder are disposed between the magnetic poles.

4. The rotor according to claim 1, wherein the minimum spacing between the first rotor holder and permanent magnets disposed in the laminated rotor core, and/or the minimum spacing between the second rotor holder and permanent magnets disposed in the laminated rotor core, are/is 4 mm.

5. The rotor according to claim 1, wherein bores which are disposed in the laminated rotor core and of which some are populated by balancing weights are kept clear in the first rotor holder and/or in the second rotor holder.

6. The rotor according to claim 1, wherein the first rotor holder and/or the second rotor holder in the region of a connecting means are/is kept clear for aligning and/or connecting laminated rotor sheets of the laminated rotor core.

7. A method for producing a rotor for an electric machine, said method comprising:
providing a rotor shaft;
pressing a laminated rotor core onto the rotor shaft;
pressing a first rotor holder onto the rotor shaft so as to be adjacent to the laminated rotor core on one side of the latter; and/or
pressing a second rotor holder onto the rotor shaft so as to be adjacent to the laminated rotor core on a second, opposite side of the latter.

8. A method for producing a rotor for an electric machine, said method comprising:
providing a rotor shaft and a laminated rotor core;
aligning a first rotor holder and a second rotor holder relative to the laminated rotor core such that the first rotor holder bears on one end of the laminated rotor core and the second rotor holder bears on another end of the laminated rotor core;
bracing the first and the second rotor holder with the laminated rotor core so as to obtain a braced composite from the first rotor holder, the second rotor holder and the laminated rotor core;
heating the braced composite and inserting the rotor shaft without force into the heated braced composite; and
allowing the heated braced composite having the rotor shaft inserted therein to cool so as to obtain the rotor.

9. A method for producing a rotor for an electric machine, said method comprising:
providing a cooled rotor shaft and a laminated rotor core;
aligning a first rotor holder and a second rotor holder relative to the laminated rotor core such that the first rotor holder bears on one end of the laminated rotor core and the second rotor holder bears on another end of the laminated rotor core;
bracing the first and the second rotor holder with the laminated rotor core so as to obtain a braced composite from the first rotor holder, the second rotor holder and the laminated rotor core;
inserting the cooled rotor shaft without force into the braced composite; and
warming the braced composite having the rotor shaft inserted therein so as to obtain the rotor.

10. The method according to claim 7, the first rotor holder and/or the second rotor holder are/is stamped or cut from a metal sheet and only the internal diameter of a press-fit is machined by turning and/or grinding.

11. An electric machine having a rotor according to claim 1, said rotor in relation to the stator being mounted so as to be rotatable about the rotation axis of the rotor.

12. A vehicle having at least two axles, of which at least one is driven, wherein said driving action is performed at least partially or temporarily by the electric machine according to claim 11.
